(19) United States
(12) Patent Application Publication
(10) Pub. No.: US 2009/0127327 A1
(43) Pub. Date: May 21, 2009

(54) Method and apparatus for delivery tracking correlated with barcode images

(75) Inventor: Ananth Rani, Fremont, CA (US)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: XORA, INC.

(21) Appl. No.: 12/313,439

(22) Filed: Nov. 20, 2008

Related U.S. Application Data
(60) Provisional application No. 61/003,854, filed on Nov. 20, 2007.

(51) Int. Cl. G06F 17/40

(52) U.S. Cl. 235/375

(57) ABSTRACT

A method and apparatus for tracking delivery of items by receiving an image of a barcode, where the barcode relates to the item delivery; processing the received image of the barcode; processing location information comprising information about the time and location of the item delivery; and analyzing the retrieved image of the barcode and the image of the barcode to determine the delivery status of the item.

### CROSS-REFERENCE TO RELATED APPLICATIONS

This application claims benefit of U.S. Provisional Application Ser. No. 61/003,854, filed Nov. 20, 2007, which is herein incorporated by reference.

### BACKGROUND OF THE INVENTION

1. Field of the Invention

Embodiments of the present invention generally relate to tracking deliveries performed by employees at various locations and, more particularly, to method and apparatus for multimedia content to analyze barcode information to track delivery services performed by the employees.

2. Description of the Related Art

Presently, if an item is sent to a customer through a courier, the customer has to fill out and sign a hard copy form, which provides a “proof of delivery”. Typically, proof of delivery provides evidence that the delivery of an item has been successfully completed at the correct location. In a typical example, the employee of the courier company provides a hardcopy of the proof of delivery to the employer/courier. One of the biggest obstacles to such a paper-based environment is that employer has no way to track whether the package was delivered to the correct location. In addition, there is generally a time-lag between a delivery to a wrong location and the realization of the mistaken delivery. Consequently, even when a mistake is discovered, the package will ultimately be delivered late. Additionally, it is possible for employees to defraud their employers and/or their customers by reporting completed deliveries that were not delivered correctly. Further, some customers may complain about the quality of a delivery service, when items were not properly delivered or delivered in an unacceptable condition, when, in fact, proper delivery had occurred. Hence, hardcopies are not necessarily a reliable or sufficient way to provide an accurate and timely proof of delivery of an item.

To alleviate the problems arising from a paper-based system, barcodes have been utilized for identifying information regarding pricing and other data for packaged goods. Although in recent years, barcodes have acquired new purposes as computers and barcode scanners have become portable. However, such handheld scanners are expensive.

Therefore, there is a need for a method and apparatus for tracking deliveries of items that eliminates the need of a handheld scanner, while providing an employer real time access to the present status of item delivery.

### SUMMARY

Embodiments of the present invention relate to a method and apparatus for tracking delivery of items by receiving an image of a barcode, where the barcode relates to the item; processing the received image of the barcode; processing location information comprising information about the time and location of the item delivery; and analyzing the retrieved image of the barcode and the image of the barcode to determine the delivery status of the item.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating capture of an image related to a barcode on an item;

FIG. 2 is a block diagram representation of a system for transmitting an image related to the barcode, according to an embodiment of the present invention;

FIG. 3 is a flowchart of a method utilized by a client for providing an image of a barcode, according to one embodiment of the present invention; and

FIG. 4 is a flowchart of a method utilized by the controller to analyze an image of a barcode, according to one embodiment of the present invention.

### DETAILED DESCRIPTION

Certain delivery services are executed or completed at remote locations, for example, delivering of items by a courier company (or organization) at a particular location. To meet the required quality of service, employees of the courier company are required to deliver the item, in good condition, to the specified location, within a specified time frame. Further, it is required that the employee has proof of the item being delivered, and satisfying the above parameters. Embodiments of the present invention capture an image of a barcode, without using a barcode scanner, send the image and location information associated with a delivery to a controller, and process the barcode image and location information for confirmation of proper delivery.

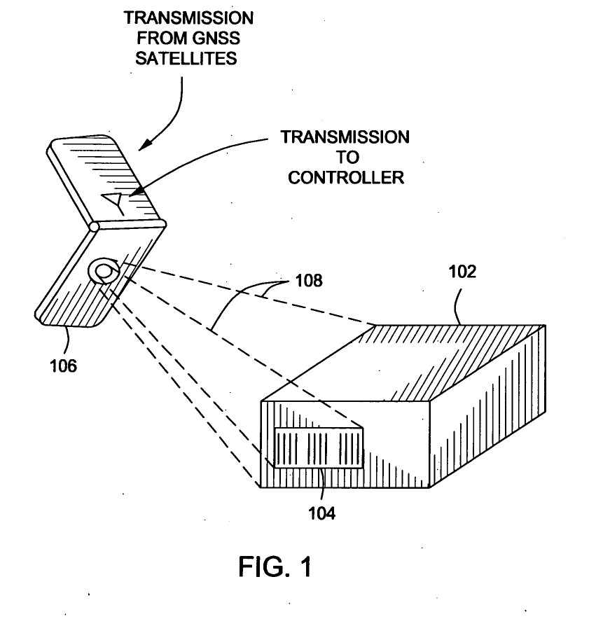

FIG. 1 illustrates a client unit 106 for capturing an image of a barcode 104 affixed to an item 102. The barcode 104 is used to distinguish item 102 from other similar items. Those skilled in the art will appreciate that the barcode 104 may differ from one item to another and may be any barcode that differentiate one item from another.

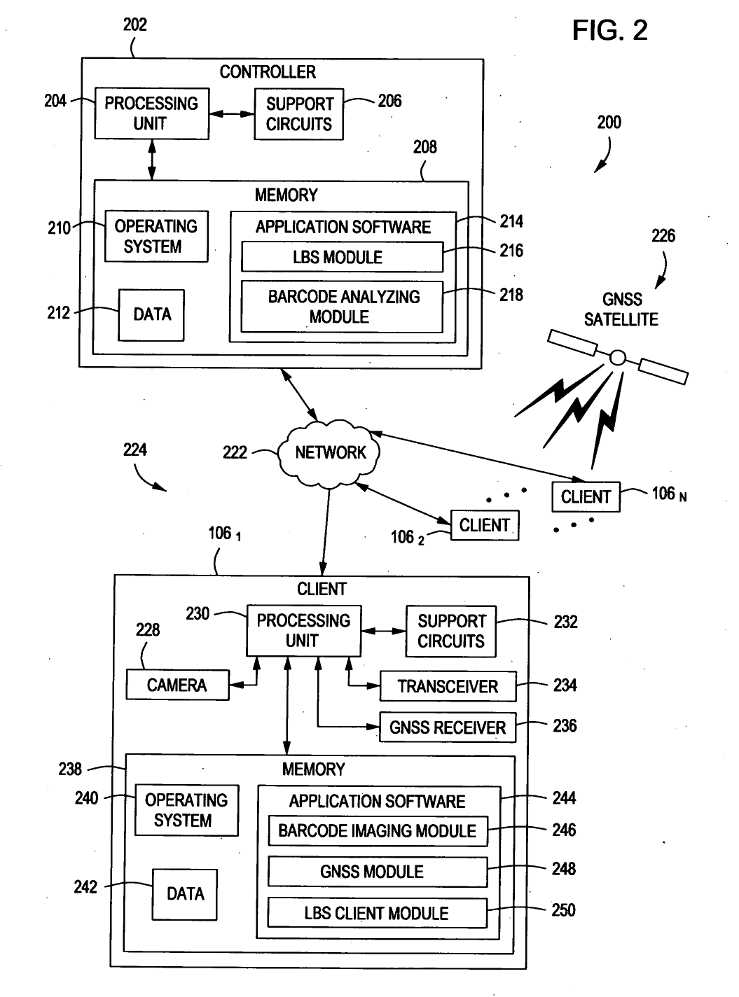

The client unit 106 is used to capture an image of the barcode 104 and transmit the image to a controller as described with respect to FIG. 2 below. In one embodiment, the client unit 106 is a cellular telephone comprising a camera and a Global Navigation Satellite System (GNSS) receiver. As such, the image may be associated with a location when sent to the controller (a location based services server). In one embodiment, the image captured by the client unit 106 is configured to be sent with other details about the proof of delivery, such as, item delivered in good condition, time and/or location details related to the delivery service of the item 102, and the like. It is appreciated here that in order to provide evidence of a delivery in good condition of item 102, the employee may take an image of the whole item 102 using a camera. In one embodiment, the image 108 may capture the barcode 104 and the whole item 102.

In one embodiment, the barcode 104 may be decoded by the client unit 106. Therefore, the barcode 104 may include various types and amounts of information that trigger various types of activity. The decoding of the barcode 104, by the client unit 106 or any computing system, may trigger sending of a text message, sending of an email, invoke a URL or a workflow event, and the like. As such, the decoding of the barcode 104 may also trigger parts lookup, inventory queries, pricing queries, a change in workflow, and the like.

FIG. 2 is a block diagram representation of a system 200 for transmitting an image related to the barcode at a location of where the image was captured, according to an embodiment of the present invention. The system 200 comprises a controller 202 (e.g., a location based services (LBS) server), a communication network 222, a network of Global Navigation Satellite System (GNSS) satellites 226 (e.g. Global Positioning System (GPS), Galileo, GLONASS, and the like) and clients 106₁, 106₂ . . . 106ₙ (collectively referred to as client 106). The controller 202 is connected to the communication network 222. The client units (client) 106 are communicably coupled with the communication network 222 and/or the GNSS satellites 226.

The controller 202 comprises a processing unit 204, various support circuits 206 and a memory 208. The processing unit 204 may be one or more of any commercially available microprocessors or microcontrollers. The support circuits 206 comprise circuits and devices that support the operation of the processing unit 204. Support circuits 206 include, for example, cache, input/output circuits, system bus, PCI bus power supplies clock circuits, and the like. Those skilled in the art will appreciate that the hardware depicted in the FIG. 2 may vary from one system to another. For example, other peripheral devices, such as optical disk drives, graphics card, data storage devices, various other input devices and the like, may also be used in addition to or in place of the hardware depicted.

Various types of software processes or modules and information reside within the memory 208. For example, various processes such as an Operating System (OS) 210, data 212 and application software 214 may be resident in the memory 208. The OS 210 may be one of a number of commercially available operating systems such as, but not limited to, SOLARIS from SUN Microsystems, Inc., AIX from IBM Inc., HP-UX from Hewlett Packard Corporation, LINUX from Red Hat Software, Windows 2000 from Microsoft Corporation, and the like.

The data 212 represents data comprising information related to the items, such as, image of barcodes, documents, time and/or position information associated with the delivery of the items, proof of delivery data, items delivered in good condition data, and the like. The data 212 may be any data utilized by the OS 210 and/or application software 214. The data 214 may comprise a relational database, for example, SQL from Oracle Corporation, which may be used to archive information and/or images of barcodes. The data 214 may be utilized by the OS 210.

The application software 214 includes a location based server (LBS) module 216 and a barcode analyzing module 218. The LBS module 216 is configured to receive information in relation to various items, item images, item condition, barcode images, documents, and other information associated with item delivery. For example, various documents, such as, shipping receipt, payment details, may be received by the LBS module 218. The LBS module 218 receives the barcode information over the communication network 222.

The barcode analyzing module 218 is configured to analyze data related to an item, including the image of the barcode related to the item. The barcode analyzing module 218 is configured to analyze the image and decode the barcode, thereby providing an analyzed data for the item. In one embodiment, a database comprises the data 212, which includes the barcode information. Thus, a barcode image retrieved from the client 224 is analyzed and compared to the barcode information in the database. The LBS module 218 may communicate the barcode information and delivery location information to users via the network.

The application software 214 may further be configured to combine the analyzed data with other information related to the item, including, time and/or location of delivery, proof of delivery, proof of item delivered in good condition, shipping and payment details, and the like. This combined data may be then stored by data 212. Those skilled in the art will appreciate that capability for the controller 202 to collect and remotely process such data allows for closure of a delivery job for the item, in real time or substantially in real time.

The communication network 222 may be one of the many communications networks generally known in the art, including, but not limited to, a cell phone network, the internet, a public and/or a private network (e.g. a Local Area Network (LAN), Wide Area Network (WAN)) and the like.

The client 106 includes a processing unit 230, support circuit 232, transceiver 234, GNSS receiver 236, a camera 228 and memory 238. In one embodiment, the client 106 is a mobile device, such as, a cell phone that comprises a GNSS receiver 236 and a camera 228.

The processing unit 230 may comprise one or more conventionally available microprocessors. The support circuits 232 are well known circuits used to promote functionality of the processing unit 230. The support circuits 232 may include conventional cache, power supplies, clock circuits, data registers, I/O circuitry, and the like to facilitate operation of the client 106.

The transceiver 234 is a combination of transmitter/receiver that communicates with the network 222. The term transceiver may be used for wireless communications devices, such as, cellular telephones, cordless telephone sets, handheld two-way radios, mobile two-way radios and the like. The GNSS receiver 236 may include electronic equipment that receives Global Positioning System (GPS) signals for processing. Those skilled in the art will appreciate that the GNSS receiver 236 may be configured to compute the location of the client 106 utilizing the signals received from the GNSS satellites 226. In other embodiments, the client 106 may use the GNSS receiver 236 to receive GNSS signals and send the GNSS signals (or portions thereof) to the controller 202 for processing in order to compute a location of the client.

The client 106 comprises a camera 228. The camera 228 is utilized for capturing an image of a barcode affixed to an item or package, as shown in FIG. 1. The images of the barcodes are transmitted to the controller 202 via communication network 222 and may be archived in the controller's data 212. The barcode images are utilized by the barcode analyzing module 218 and the document and barcode module 216 for matching/analyzing the barcode information and/or images archived in the data 212 of the controller 202. Although the camera 228 is described as a component of the client 106, the camera may be a stand alone device that communicates with the transceiver of the client to send images to the controller 202.

The client memory 238 may be random access memory, read only memory, for example PROM, EPROM, EEPROM and the like, removable storage such as optical disk, tape drive and the like, hard disk storage, flash drives or any combination of such memory devices. The client memory 238 may include an operating system (OS) 240, data 242 and application software 244. The operating system 240 may be one of a number of commercially available operating systems used on mobile platforms. The data 242 may be utilized by the OS 240.

The application software 244 may include one or more applications executing/utilized by the client 106, such as, an imaging module 246, a GNSS module 248, and an LBS client module 250. The barcode imaging module 246 processes images for transmission, e.g., encoding compression and the like. Using the LBS client module 250, the client 106 transmits such images to the controller 202 via communication network 222. In addition to the images, the client transmits the location of client device when the image was captured. The GNSS module 248 is used to compute the location. In one embodiment of the invention, the data is transmitted via short message service (SMS) messages, email messaging, and the like. The controller 202 utilizes the images for analysis and/or comparisons. For example, the client 106 may utilize the barcode imaging module 246 to process a barcode image captured by the camera 228 and transmit the barcode image to the controller 202. The controller 202 analyzes the barcode image and compares the image or other representation of the barcode to barcode information in a database in the data 212 of the controller 202. If the barcode image matches the barcode information, the controller 202 archives the image received from the client 106 and associates the image with the relevant items/package information in the data 212 of the controller 202.

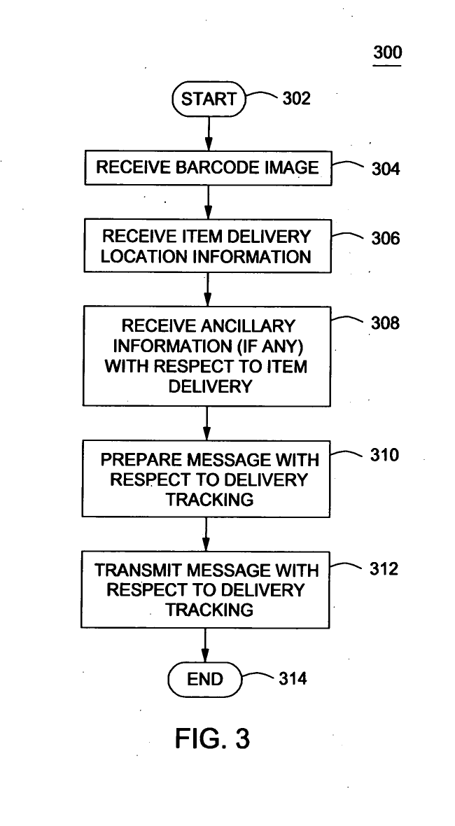

FIG. 3 is a flow diagram of a method 300 of operation of the client (e.g., executing the LBS client module), according to one embodiment of the invention. The method 300 starts at step 302 and proceeds to step 304 wherein the method receives an image. The image comprises at least one image of the barcode and may comprise other images of the environment of the delivery. The image(s) are conventionally generated by the camera and the imaging module.

At step 306, the method 300 receives delivery location information from the GNSS module. At step 308, ancillary information (if any) is created and/or accessed and made available to the method 300. The ancillary information may include recipient name, address, and the like. At step 310, a delivery tracking message, such as an SMS message, is prepared containing the image(s), location information and ancillary information (if any). At step 312, the message is transmitted to the controller. The method 300 ends at step 314.

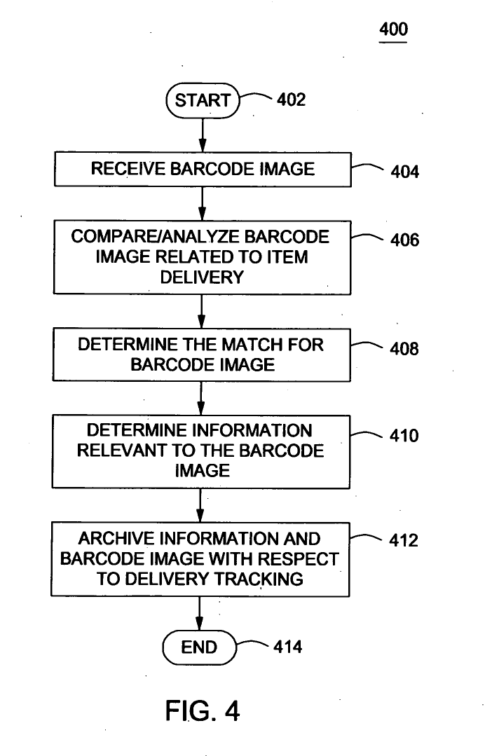

FIG. 4 is a flowchart of a method 400 utilized by the controller to analyze an image of a barcode, according to one embodiment of the present invention. The method 400 starts at 402 and proceeds to step 404. At step 404, an image of an item barcode is received. At step 406, the image of the barcode is analyzed and compared to archived barcode information. At step 408, the matching barcode information is determined. At step 410, information relating to the barcode is determined, such as, delivery condition, status, time and/or location of the item and the like. At step 412, the method 400 archives information relating to the barcoded item, such as images, documents, and the like. The method 400 ends at step 414.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is intended to cover all modifications, equivalents, and alternatives falling within the spirit and scope of the invention.

What is claimed is:

1. An apparatus for providing delivery tracking information, comprising:
a client, for capturing a barcode image related to an item delivery, determining location information related to the item delivery, and sending the barcode image and location information to a remotely located controller for processing.

2. The apparatus of claim 1 wherein the client is coupled to the controller via a communication network.

3. The apparatus of claim 1 further comprising a camera, coupled to the client, for capturing at least one image of a barcode affixed to a deliverable item.

4. The apparatus of claim 2 wherein the controller comprises a barcode analyzing module for processing the barcode and location information related to the item delivery.

5. The apparatus of claim 1 wherein the location information comprises information about the time and location of the item delivery.

6. The apparatus of claim 4 wherein the barcode image analyzing module analyzes the barcode image and the location information to provide delivery tracking information.

7. The apparatus of claim 6 wherein the delivery tracking information comprises at least one item delivery condition, time and location of the item delivery, proof of delivery and proof of item delivered in good condition.

8. A method for providing delivery tracking correlated with barcode images comprising:
capturing a barcode image, wherein the barcode is related to an item delivery;
determining location information related to the item delivery; and
transmitting the barcode and location information related to an item delivery to controller for processing.

9. The method of claim 8 further comprising analyzing, at the controller, the barcode and location information related to an item delivery to determine the delivery tracking information.

10. The method of claim 8 wherein the location information comprises information about the time and location of the item delivery.

11. The method of claim 8 further comprising comparing the present barcode information related to the item delivery to a retrieved barcode information.

12. The method of claim 8 further comprising matching the present barcode information related to the item delivery to a retrieved barcode information.

13. The method of claim 8 wherein the analyzing step utilizes tracking information related to an item delivery at the time and location relevant to the item delivery.

14. The method of claim 8 further comprising generating delivery tracking information related to an item delivery.

15. The method of claim 14 wherein the delivery tracking information comprises at least one item delivery condition, time and location of the item delivery, proof of delivery and proof of item delivered in good condition.

16. A system for providing delivery tracking correlated with barcode images comprising:
a client, for capturing a barcode image related to an item delivery, determining location information related to the item delivery, and sending the barcode image and location information to a remotely located controller for processing; and
a barcode analyzing module, contained in the controller, for processing the barcode image and location information related to the item delivery.

17. The system of claim 16, wherein the barcode analyzing module analyzes the barcode image and location information to provide delivery tracking information.

18. The system of claim 16, wherein the delivery tracking information comprises at least one item delivery condition, time and location of the item delivery, proof of delivery and proof of item delivered in good condition.
